(19) United States
(12) Patent Application Publication
(10) Pub. No.: US 2019/0084638 A1
(43) Pub. Date: Mar. 21, 2019

(54) Leaning Quad-Wheeled All-Terrain Vehicle

(71) Applicant: Thomas W. Melcher, Mesa, AZ (US)

(72) Inventor: Thomas W. Melcher, Mesa, AZ (US)

(21) Appl. No.: 16/138,849

(22) Filed: Sep. 21, 2018

Related U.S. Application Data
(60) Provisional application No. 62/561,351, filed on Sep. 21, 2017.

(51) Int. Cl. B62K 5/10; B62K 5/08; B62K 5/01; B62L 1/00; B62M 11/00

(52) U.S. Cl. CPC B62K 5/10; B62K 5/08; B62K 2005/001; B62L 1/00; B62M 11/00; B62K 5/01

(57) ABSTRACT

A vehicle suspension includes a center block and a suspension arm pivotally coupled to the center block. A hydraulic actuator is coupled between the center block and suspension arm. A wheel is mounted to the suspension arm opposite the center block. The hydraulic actuator is configured to lean the wheel. A brake rotor is mounted to a rim of the wheel through springs. A brake stanchion extends from a center of the wheel. The brake stanchion includes a center-mounted brake caliper. An axle is pivotally coupled to the center block at a first end of the axle. A constant velocity (CV) joint is mounted to a hub of the wheel with a second end of the axle extending into the CV joint. A steering tie rod is attached to a housing of the CV joint. The center block is attached to a vehicle frame.

### CLAIM OF DOMESTIC PRIORITY

The present application claims the benefit of U.S. Provisional Application No. 62/561,351, filed Sep. 21, 2017, which application is incorporated herein by reference.

### FIELD OF THE INVENTION

The present invention relates to vehicles, and more particularly to a leaning quad-wheeled all-terrain vehicle (ATV).

### BACKGROUND

ATVs are a booming industry. Putting a leaning suspension on a quad-wheeled ATV (quad) would increase the capabilities, as well as the safety, of ATVs. However, trying to make a leaning quad presents many challenges. A need exists for a quad with a leaning suspension that works reliably well.

### BRIEF DESCRIPTION OF THE DRAWINGS

FIGS. 1a-1d illustrate a leaning quad;

FIGS. 2a and 2b illustrate a frame of the quad;

FIGS. 3a-3h illustrate a front suspension of the quad;

FIGS. 4a-4c illustrate the electric drive train of the front wheels integrated into the axles;

FIGS. 5a-5e illustrate brakes of the quad;

FIGS. 6a and 6b illustrate a steering system of the quad;

FIGS. 7a-7g illustrate a rear suspension of the quad; and

FIGS. 8a-8e illustrate the rear drive train of the quad.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

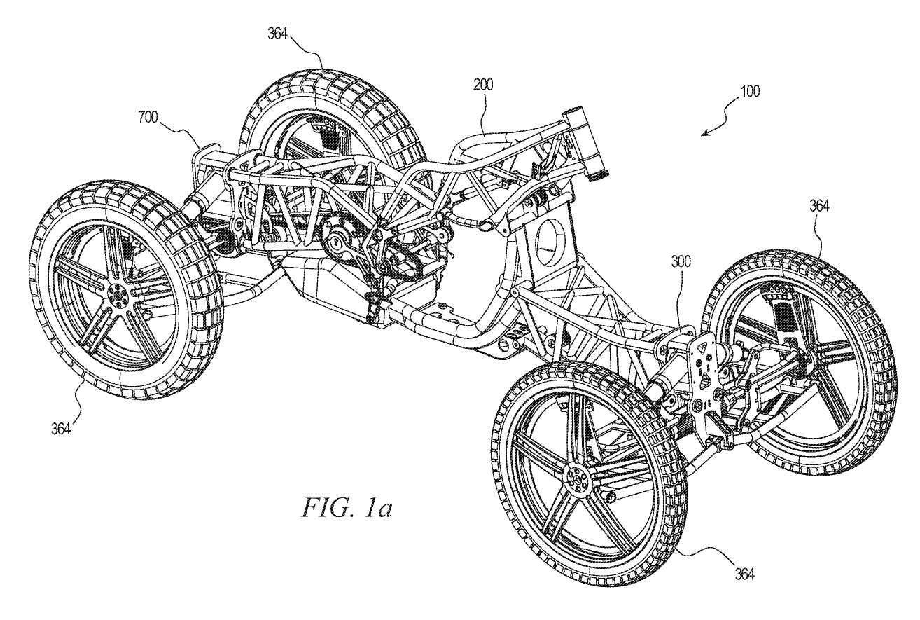

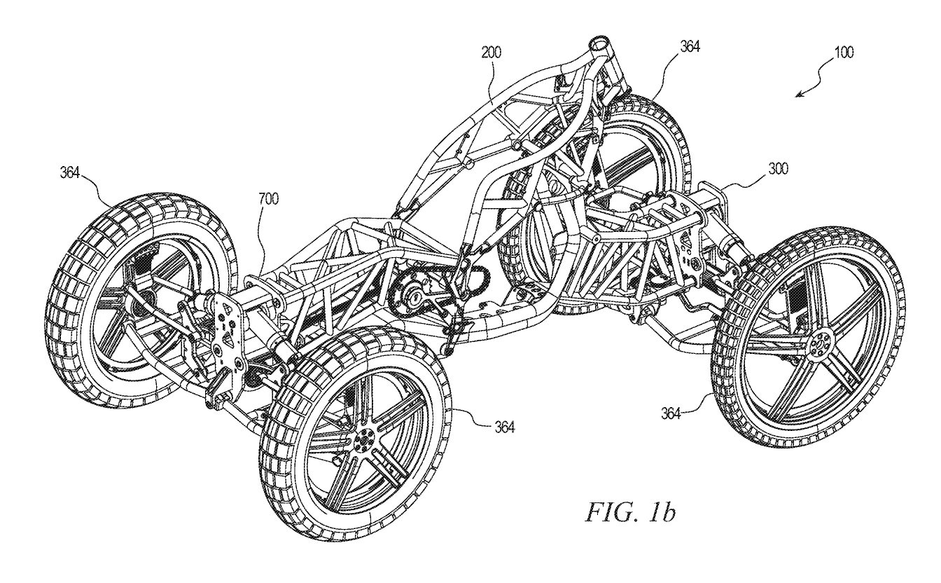

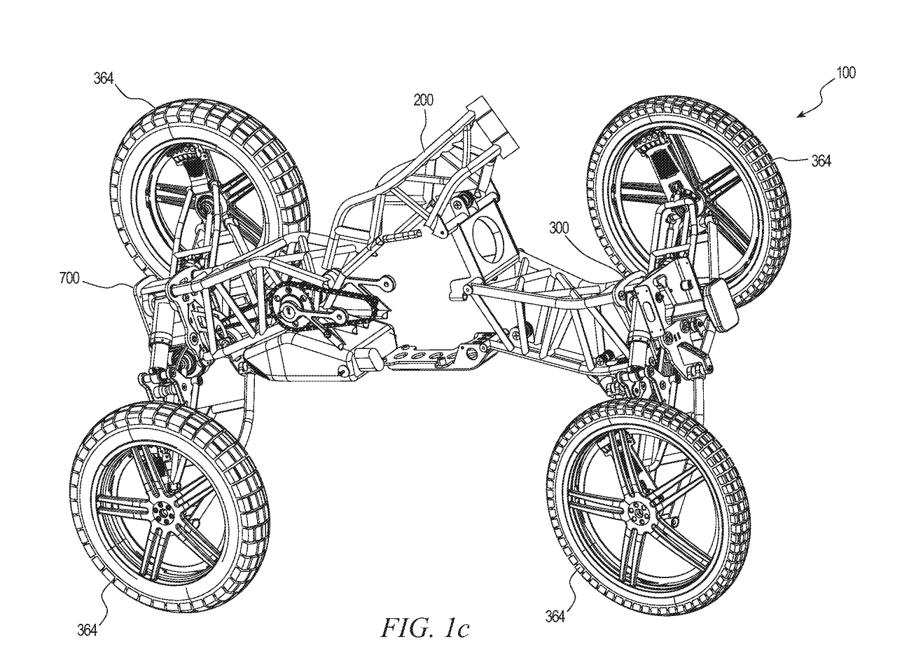

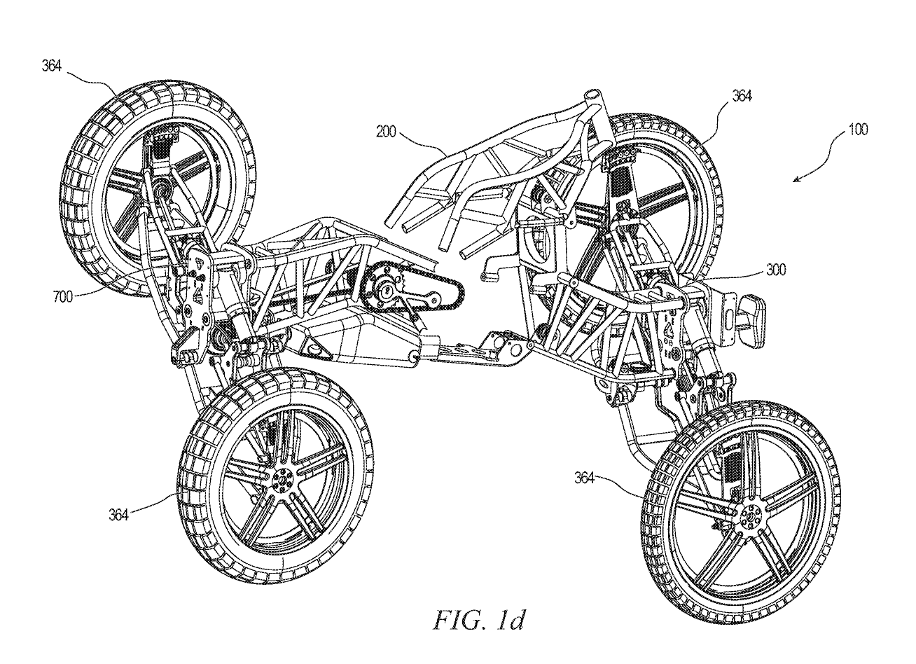

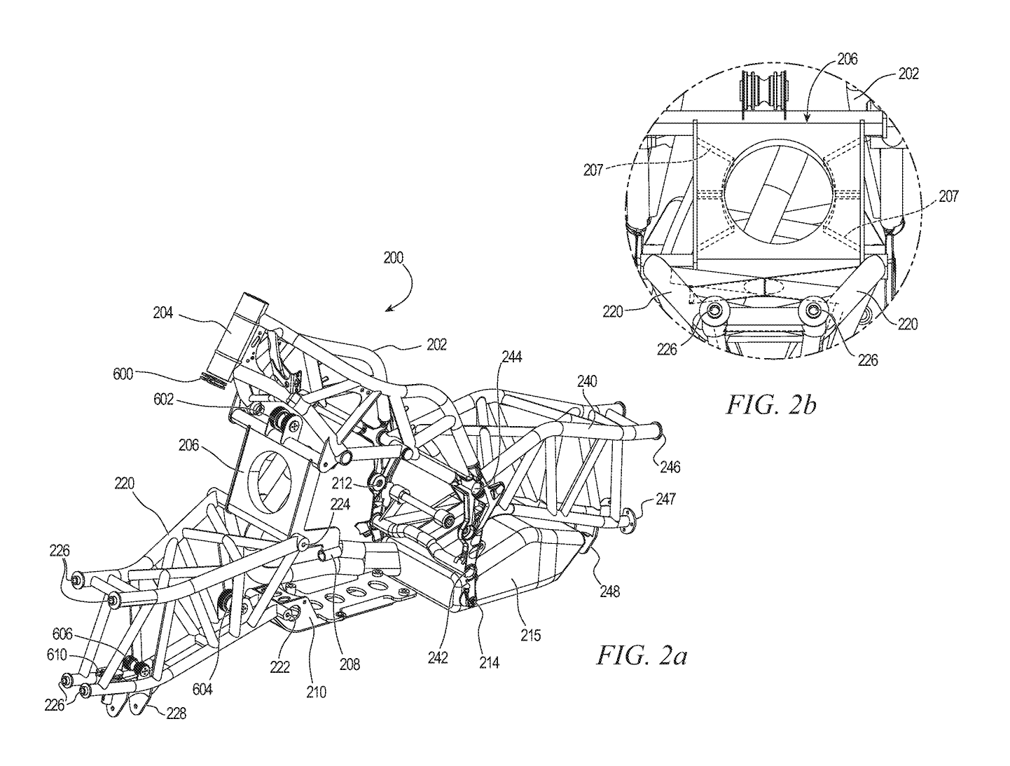

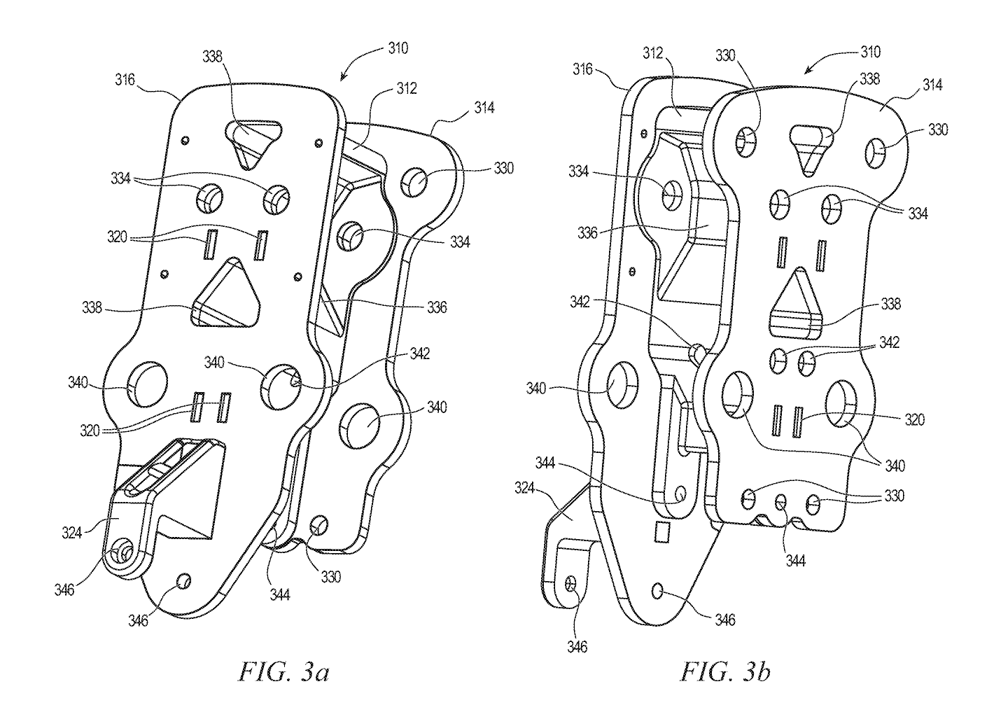

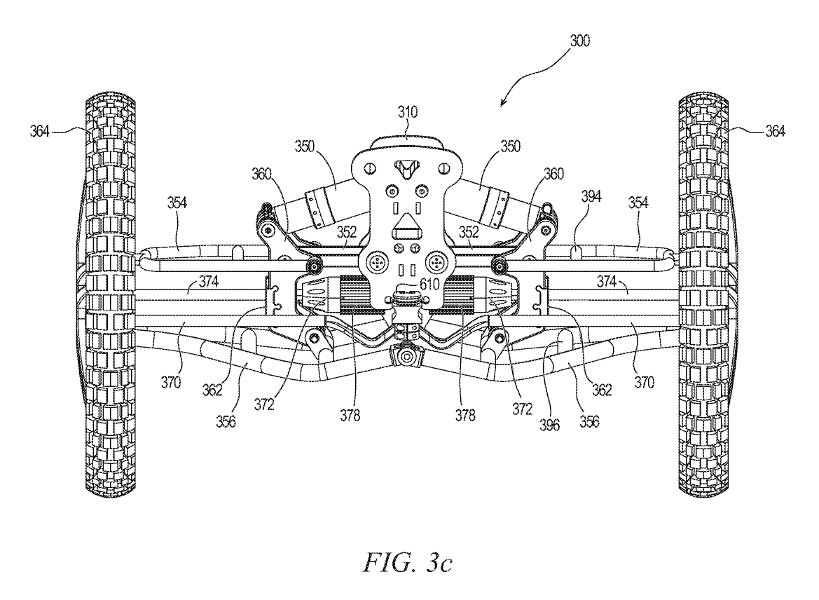

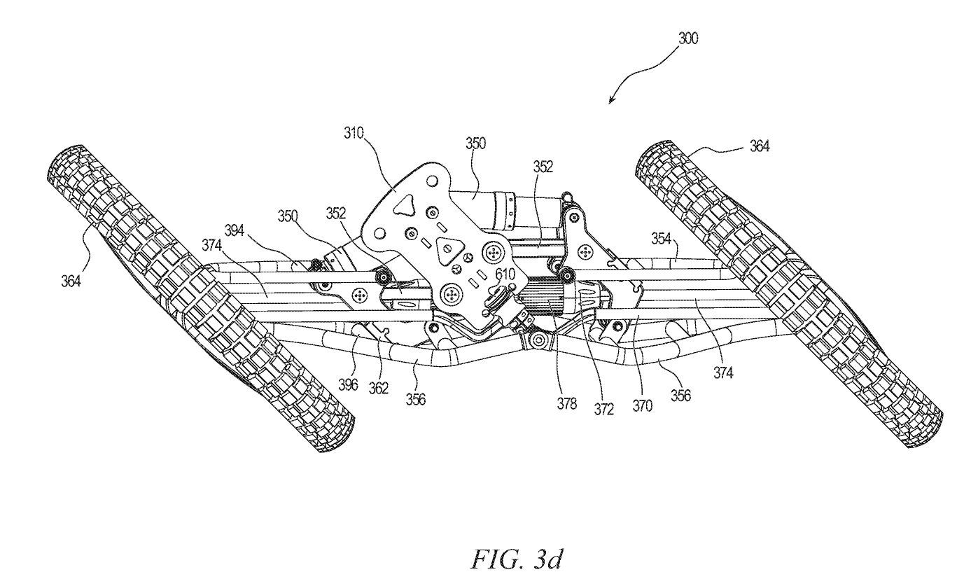

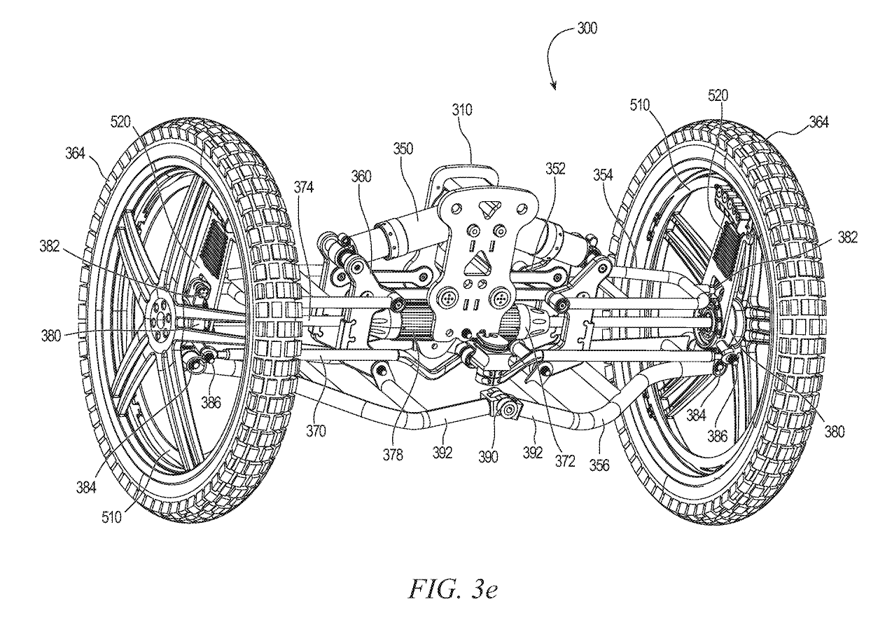

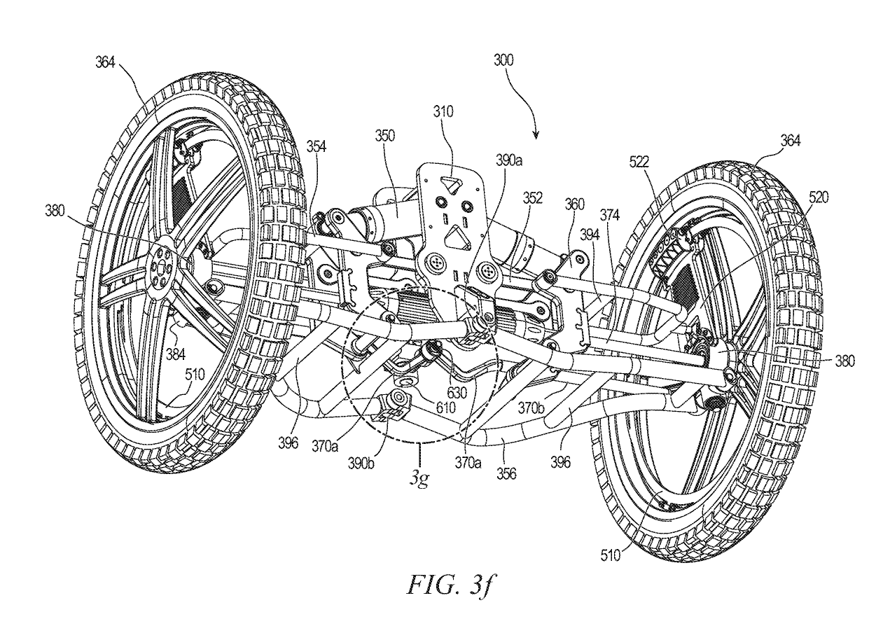

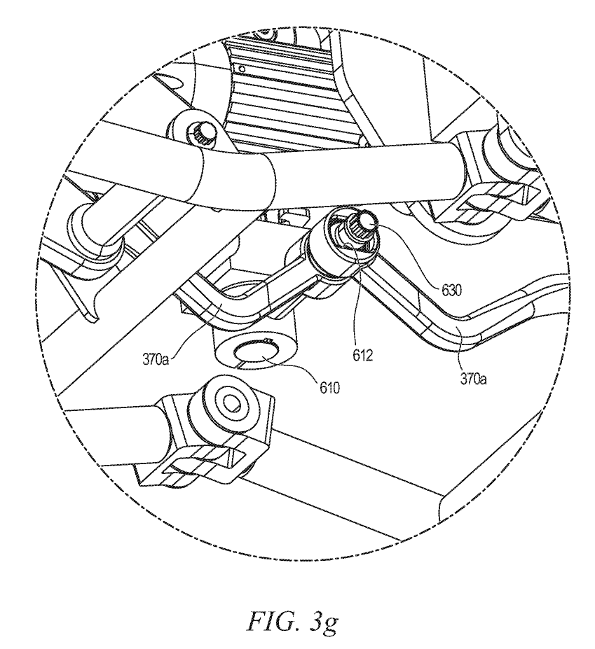

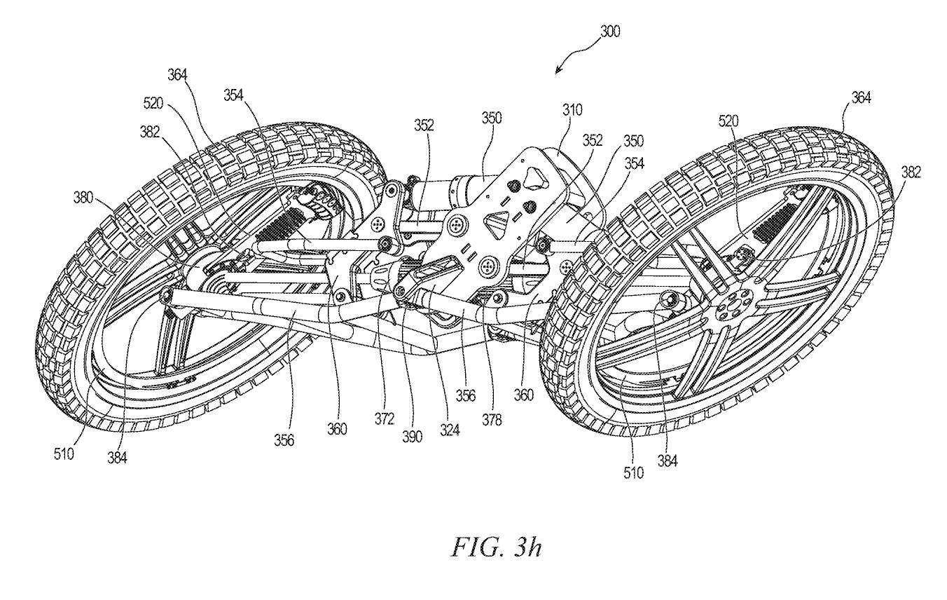

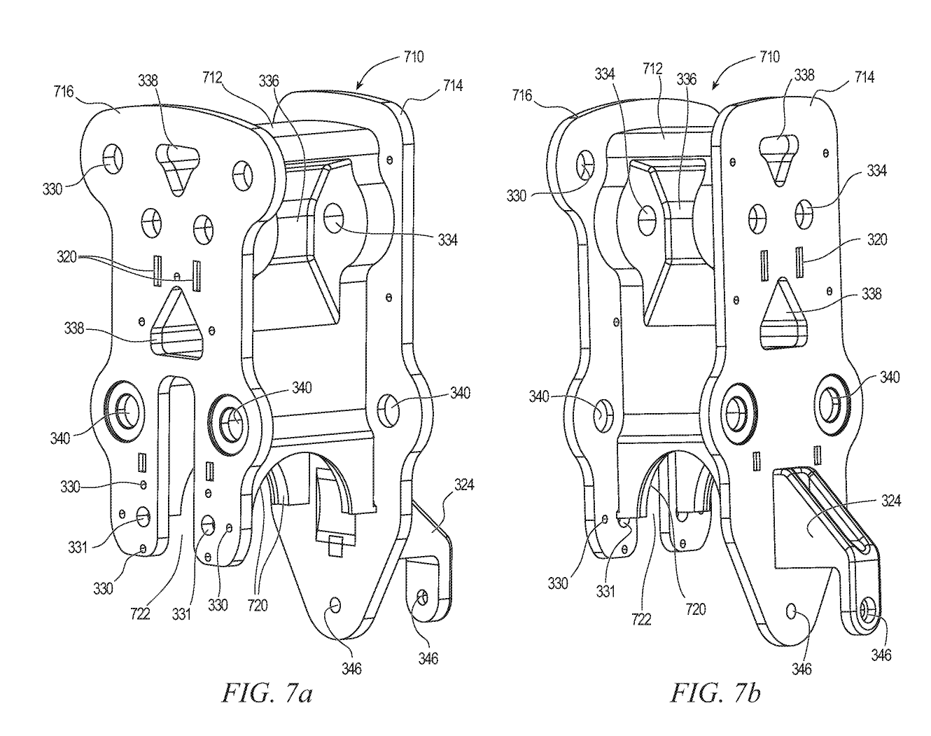

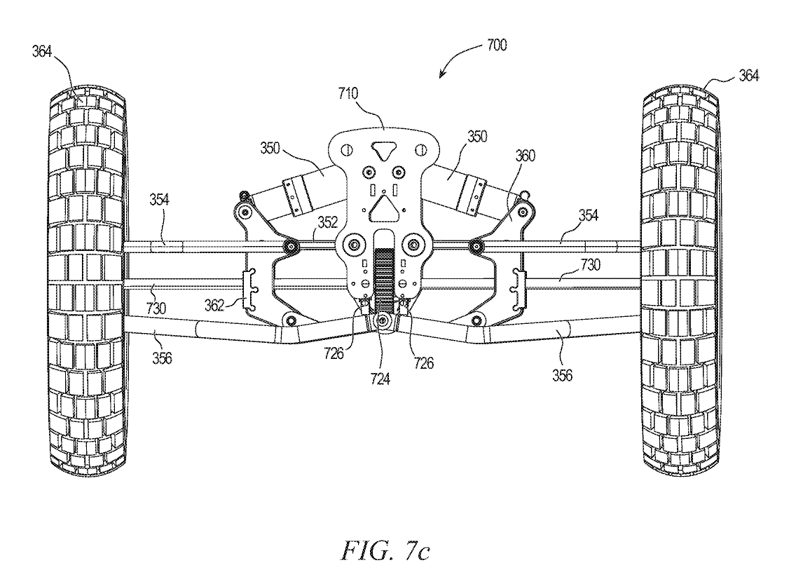

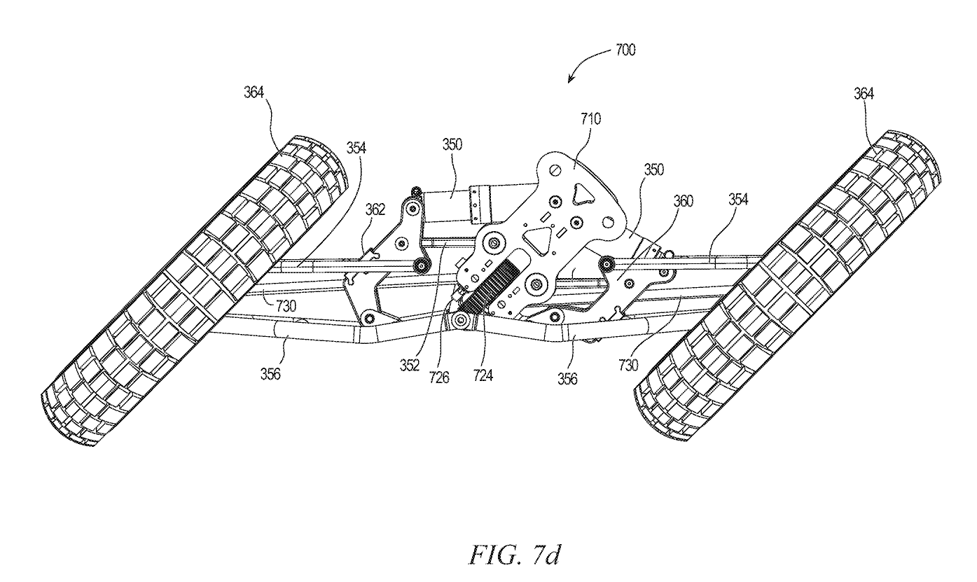

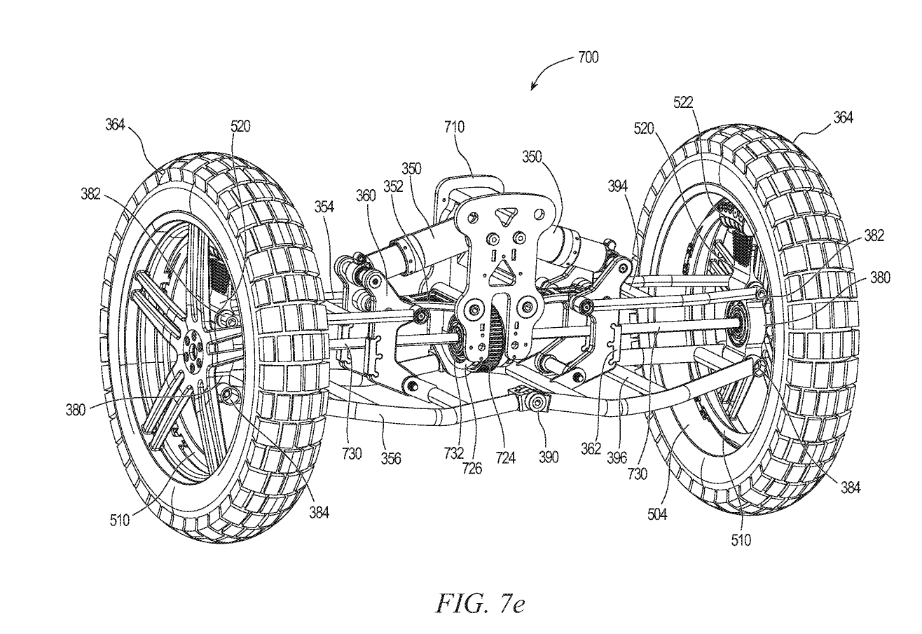

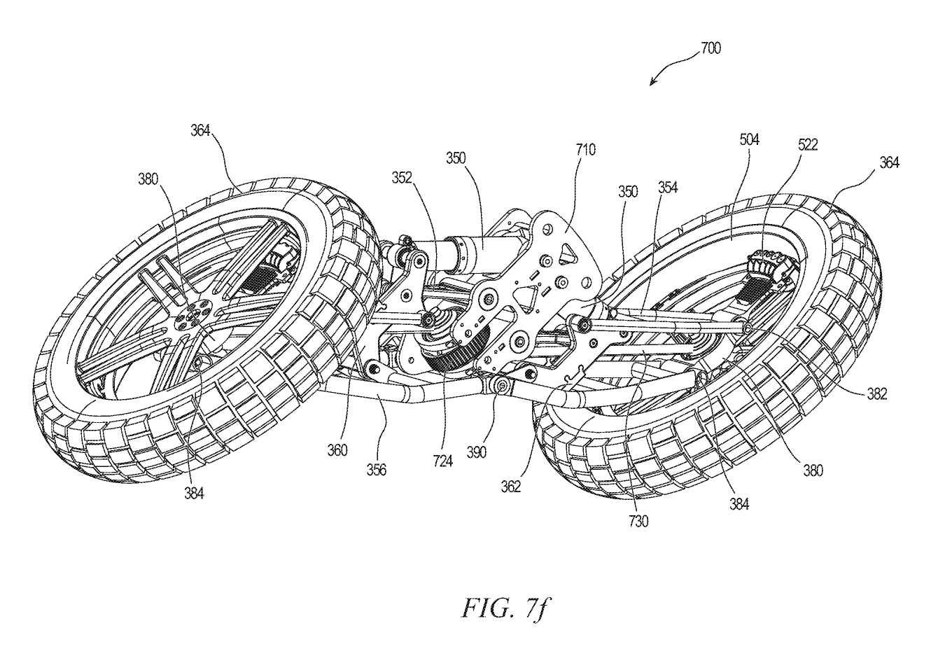

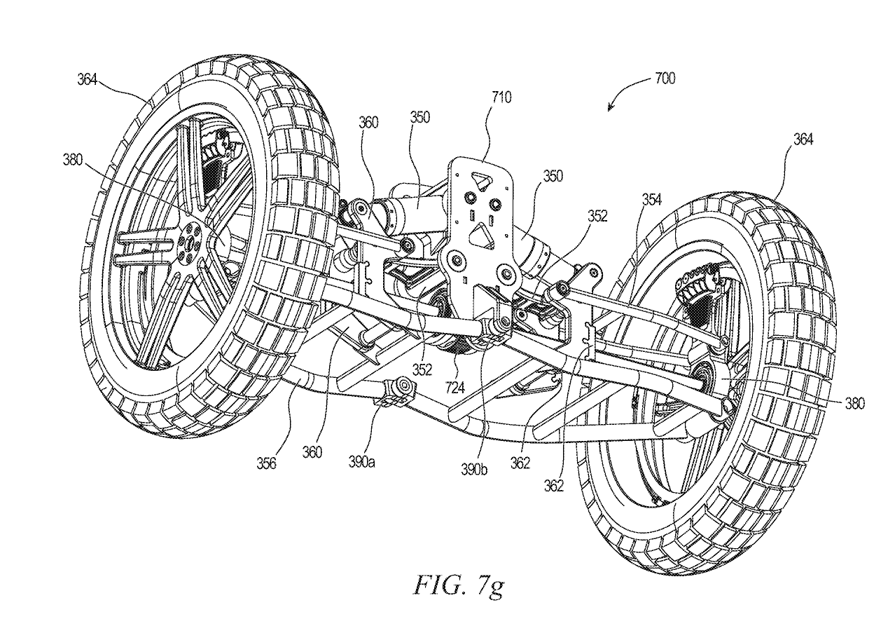

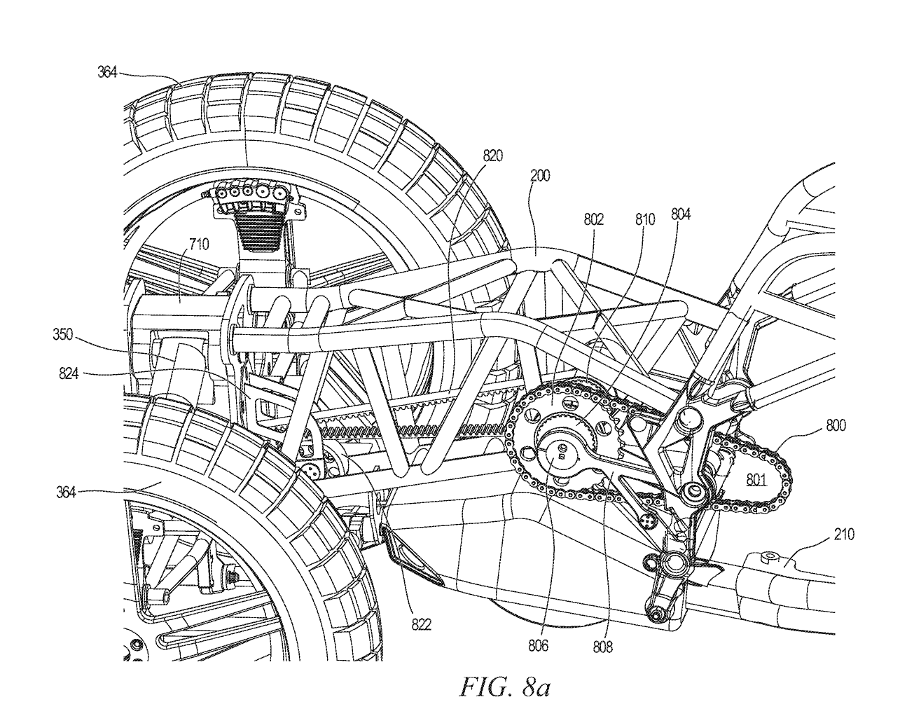

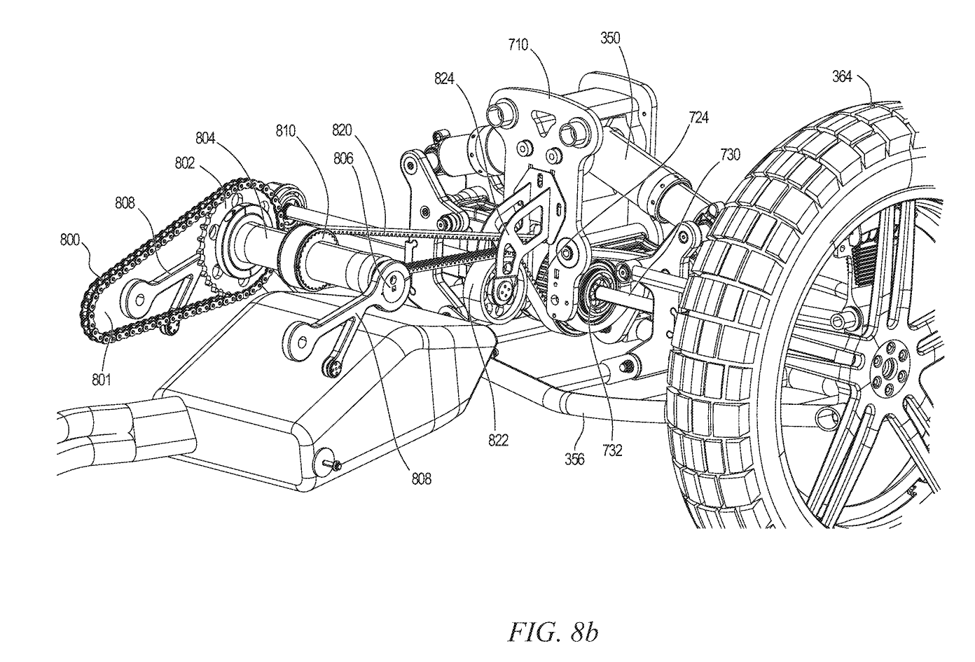

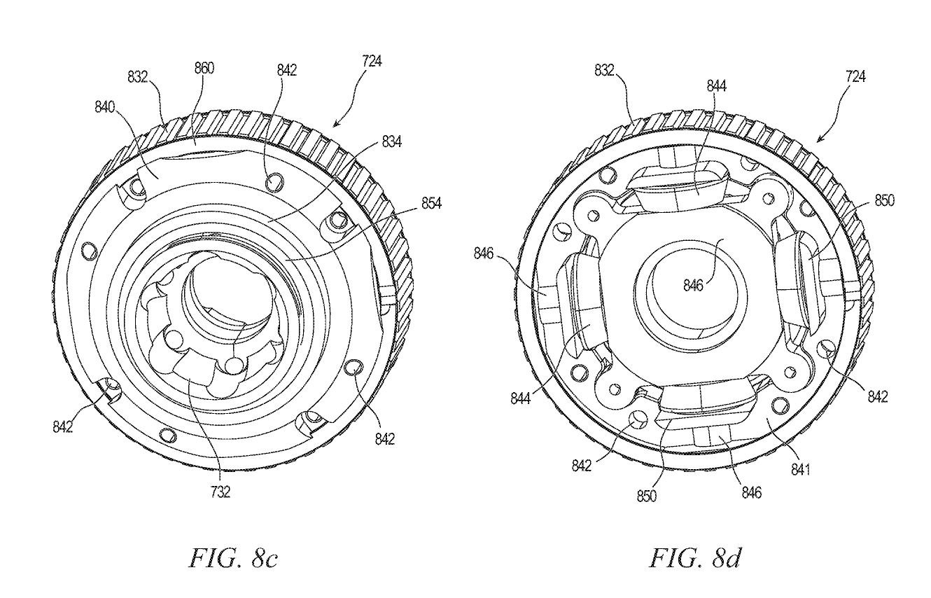

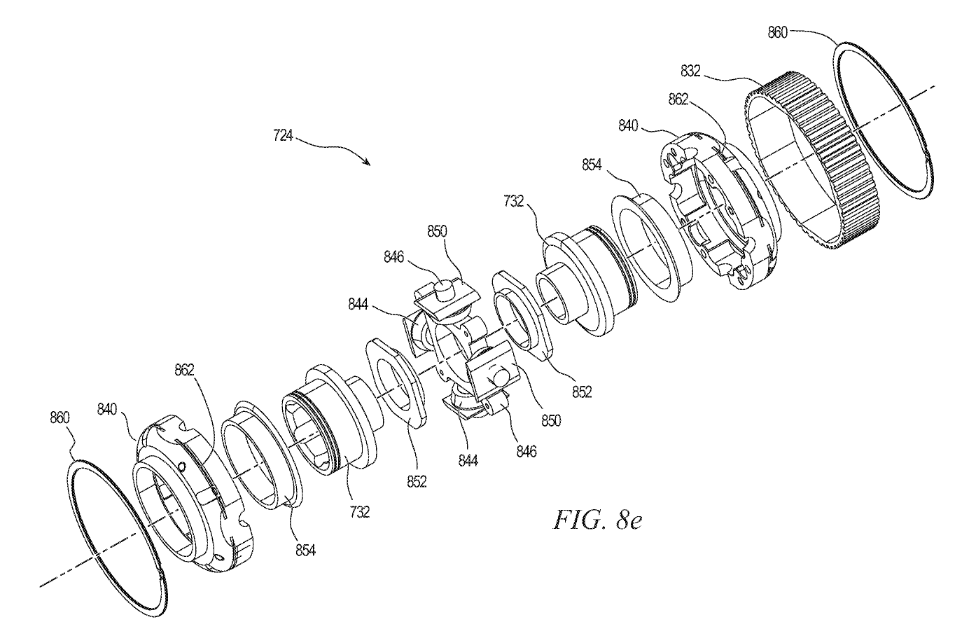

FIGS. 1a-1d illustrate a quad-wheeled ATV 100. While quad 100 is described in terms of an all-terrain vehicle, the vehicle is also suitable for normal road driving for commutes, etc. Quad 100 includes a frame 200, a front suspension 300 attached to the front of the frame, and a rear suspension 700 attached to the rear of the frame. Additional details of frame 200 are illustrated in FIGS. 2a and 2b. Additional details of front suspension 300 are illustrated in FIGS. 3a-3h, 4a-4c, 5a-5e, 6a, and 6b. Much of the disclosure for front suspension 300 applies as well to rear suspension 700. Additional details of rear suspension 700 are illustrated in FIGS. 7a-7g and 8a-8e.

FIG. 1a illustrates a perspective view of quad 100 from the front, and FIG. 1b illustrates a perspective view of the quad from the rear. The bodywork of quad 100 is not included in the figures to reveal structural and functional components. In practice, frame 200 will usually include at least the addition of a seat for a rider and handlebars to turn the wheels of front suspension 300. In some embodiments, frame 200 and the central portions of suspensions 300 and 700 are covered in body panels for a sleeker look and improved aerodynamics.

Front suspension 300 and rear suspension 700 each include a hydraulic system used to actuate the wheels of quad 100. Actuating the wheels of quad 100 is used to lean the vehicle into turns, to keep frame 200 level relative to gravity when traveling over varying terrain, or for other purposes. FIGS. 1c and 1d illustrate quad 100 with suspensions 300 and 700 leaning to the left. A left lean as illustrated in FIGS. 1c and 1d could be performed when turning left to counteract centripetal force. One inaccuracy in the figures that show suspensions 300 and 700 leaning is that the constant velocity (CV) joints did not render properly. The portions of axles within the CV joints were not leaned properly, and appear to be broken off from the main axles. However, one having ordinary skill in the art would understand that, in reality, the axle within the CV joints would move to stay continuous with the main axle. There are also some discontinuities of frame 200 in the leaning figures that are not accurate.

The hydraulic systems in suspensions 300 and 700 operate largely the same as in U.S. Pat. No. 9,545,976 (the '976 patent), which is incorporated herein by reference. Each suspension includes two hydraulic actuators that raise or lower a parallelogram formed between an upper control arm and a lower control arm. Further operation of the suspensions is explained below. Additionally, the workings of the hydraulic leaning system is thoroughly explained in the '976 patent.

FIGS. 2a and 2b illustrate detail of frame 200. Frame 200 is formed of a central trellis frame 202, a front trellis frame 220, and a rear trellis frame 240. Trellis frames use metal tubes arranged to form triangulated reinforcement using lattice girder principles. Any frame of any type from an existing ATV, motorcycle, or other vehicle can be used for frame 200. Different frame types of different materials can be grafted in any suitable combination using various attachment methods to form frame 200. Front suspension 300 and rear suspension 700 are added onto a pre-existing frame of a production vehicle to provide leaning capability in some embodiments. In the case where a motorcycle frame is used, motorcycles already lean on two wheels, but adding suspensions 300 and 700 creates a four-wheeled vehicle while retaining a similar leaning capability.

In other embodiments, middle trellis frame 202 is an existing part from a production ATV or motorcycle, and trellis frames 220 and 240 are custom manufactured to attach to the middle frame. Other types of frames are used in other embodiments, e.g., an aluminum box frame, or a carbon fiber rectangular box frame. Frame 200 is formed from carbon fiber, aluminum, steel, plastic, or any other suitable material by any suitable manufacturing method.

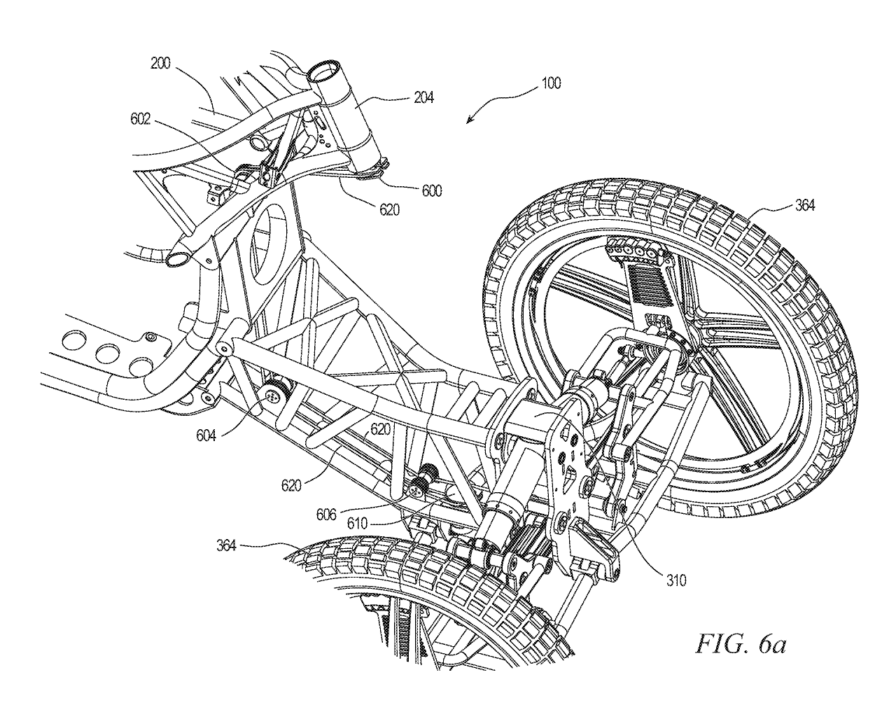

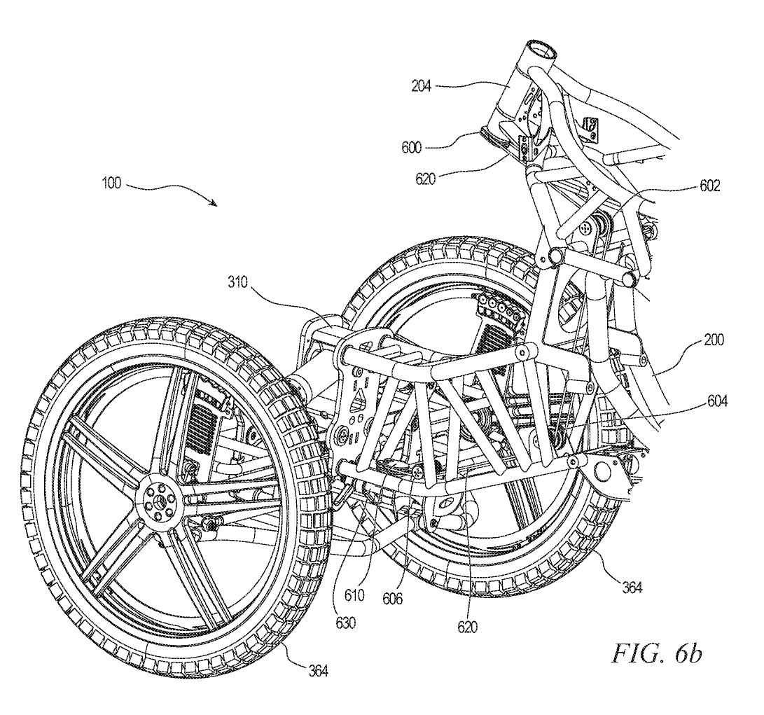

Middle frame 202 includes a steering tube 204 at the top-front of the middle frame. Handlebars are provided that include a centrally located shaft. The shaft of the handlebars is inserted through steering tube 204 and attached to pulley 600 to operate the steering. Turning the handlebars turns pulley 600 about an axis through steering tube 204. The rotation of pulley 600 turns the wheels of front suspension 300 via a cable system that is described below in relation to FIGS. 6a and 6b. Cables are routed from pulley 600 around pulleys 602, 604, and 606, and then attached to front pulley 610 at the opposite end of the cable from pulley 600. Pulley 610 includes a vertical shaft down through front frame 220 that is further attached to tie bars out to the front tires by a Pitman arm.

Middle frame 202 and front frame 220 are mechanically coupled by a torsional box 206. Torsional box 206 is hollow and includes internal trusses or ribs 207 to resist torsional flex of frame 200. FIG. 2b illustrates a cross-sectioned view of torsional box 206 with trusses 207 illustrated. Torsional box 206 includes mounting points 208 for mechanically anchoring to a combustion engine that will be disposed on platform 210.

The engine for quad 100 is mounted on platform 210 and attached to the platform and mounting points 208 using bolts or other suitable hardware. Rear frame 240 is mechanically attached to the engine at points 212. The engine provides part of the structural rigidity of frame 200, as front frame 220 and rear frame 240 are attached to each other through the engine block. Mounting points 214 allow attachment of exhaust muffler 215, and are the lowest extent of middle frame 202.

Front frame 220 is attached to middle frame 202 at the bottom of frame 200 through platform 210 and the engine. Platform 210 forms part of the front frame's trellis structure at point 222, with attachment provided by welding, bolts, or another suitable mechanism. The top of front frame 220 is attached to middle frame 202 through torsion box 206. The bottom of torsion box 206 forms part of the trellis structure of front frame 220 at point 224. Attachment points 222 and 224 are at the rear end of front frame 220. The front of frame 220 includes threaded inserts 226 welded into the front of the trellis tubes. Threaded inserts 226 allow attachment of front suspension 300. Bolts are disposed through openings in front suspension 300 and screwed into inserts 226. Other attachment mechanisms are used in other embodiments. Control arm mounting point 228 on the bottom of front frame 220 provides support for the lower control arm of front suspension 300. An axle extends through offset clevis joints of the lower control arms and through the two openings in control arm mounting point 228.

The front of rear frame 240 is attached to middle frame 202 at points 242 and 244. The trellis tubes of rear frame 240 are attached to middle frame 202 by bolts, welding, or another suitable mechanism. The rear end of rear frame 240 includes threaded inserts 246, similar to inserts 226, welded into the trellis tubes for attachment of rear suspension 700. The bottom of rear frame 240 includes flanged ends 247 rather than threaded inserts 246. Flanged ends 247 have openings formed through the flange to bolt onto rear suspension 700. Front suspension 300 and rear suspension 700 can be attached by any combination of threaded inserts and flanged tubes as desired or convenient.

FIGS. 3a and 3b illustrate a center block 310 of front suspension 300. Center block 310 provides pivot points for the parts of the suspension arms and an attachment point for front suspension 300 to frame 200. Center block 310 comprises a middle portion 312, front plate 316, and rear plate 314. Middle portion 312 is extruded to allow a custom depth between front plate 316 and rear plate 314, and then machined to form the illustrated cavities. Some openings are included in the extrusion, while others are machined after extruding. The extruded material is aluminum, steel, titanium, plastic, or any other suitable material.

Front plate 316 and rear plate 314 are cut from a sheet of material, e.g., ⅜″ plate stock, using laser cutting, water jet cutting, mechanical cutting, or any other suitable mechanism. Plates 314 and 316 can be formed from aluminum, steel, titanium, plastic, or any other suitable material. Plates 314 and 316 include openings 320 that align with tabs extending from middle portion 312. Plates 314 and 316 are placed on middle portion 312 with the tabs in openings 320. The plates are then welded onto middle portion 312 through openings 320 to form center block 310 as a stable block.

Front plate 316 includes a protrusion 324 for attachment of the lower control arms to block 310. Protrusion 324 can be welded onto front plate 316 before or after welding the rear plate to middle portion 312.

In some embodiments, middle portion 312 is completely machined or cast rather than using extrusion. In other embodiments, center block 310 is completely made out of a single casting or machined as a single piece.

Rear plate 314 includes four openings 330 for attachment of center block 310 to frame 200. Openings 330 are aligned with threaded inserts 226. Bolts are disposed through openings 330 and tightened into threaded inserts 226 to mechanically attach front suspension 300 to frame 200. One advantage of forming plates 314 and 316 separately from middle portion 312 is that rear plate 314 can be shaped differently, with appropriate repositioning of openings 330, to attach to a different frame without necessarily making any other changes to the suspension.

Center block 310 includes openings 334 for attachment of the hydraulic shock actuators. As disclosed in the '976 patent and shown below, the hydraulic actuators include upper axles that are disposed through openings 334 and allow the hydraulic actuators to pivot relative to center block 310. The upper ends of the hydraulic actuators are disposed in cavities 336 of center block 310. Forming center portion 312 as a separate extrusion allows the distance between front plate 316 and rear plate 314 to be customized for different diameter of hydraulic shocks. The extrusion can be made extra-long to allow for two shocks per side to operate in parallel as a redundancy.

Hitch receiver openings 338 extend through center block 310. Hitch receiver openings 338 allow attachment of any suitable implement to the vehicle. The implements can be functional, such as trailer hitches, lawn mowers, active lifts, or bumpers. FIG. 1c illustrates a bumper disposed in hitch receiver openings 338. The implements can also be cosmetic, such as interchangeable body stylings.

Openings 340 are formed through plates 314 and 316 for attachment of the upper control arms or control links. The control links include an axle that will attach through openings 340, allowing the control links to pivot around openings 340. Openings 342 are formed in center block 310 for routing of cables from control circuitry on frame 200 to electric motors integrated as part of front suspension 300. Openings 344 are formed for mounting of the electric motors. An axle extending between the front and back openings 344 allows for attachment and pivoting of the electric motors. Openings 346 on front plate 316 and protrusion 324 are for an axle of the lower control arm. The front offset clevis joints of the lower control arms are disposed on an axle in openings 346, while the rear offset clevis joints of the lower control arms are disposed in mounting point 228 of front frame 220.

FIGS. 3c and 3d illustrate front suspension 300 from the back, i.e., the side that attaches to frame 200. Center block 310 forms the base of front suspension 300, and other components are mounted onto the center block. Hydraulic shocks 350 are attached to center block 310 at cavities 336 with an axle that extend through hydraulic shocks 350 and openings 334. Hydraulic shocks 350 are similar to air spring shocks 68 and 88 in the '976 patent. The axle that holds hydraulic shocks 350 may include a hydraulic pathway as in the '976 patent. Control links 352 are attached to center block 310 at openings 340, and then further attached to upper control arms 354 through mechanism arms 360. Lower control arms 356 are attached to center block 310 at openings 346, and to front frame 220 at mounting point 228. Mechanism arms 360 are attached to hydraulic actuators 350 opposite center block 310, between control link 352 and upper control arm 354, and also at an intermediate point of lower control arms 356. The outboard ends of upper control arms 354 and lower control arms 356 are attached to wheels 364. Details of the attachment of wheels 364 are illustrated in subsequent figures.

The general structure and operation of the hydraulic actuators, control links, control arms, and mechanism arms is similar to the '976 patent. Wheels 364 complete a parallelogram similar to spindle shaft housings 78 and 98 in the '976 patent. FIG. 3d illustrates suspension 300 leaned to show how the parts move relative to each other through the leaning motion. Mechanism arms 360 include rubber stops 362 that hit longitudinal bars 394 in upper control arms 354 or longitudinal bars 396 in lower control arms 356 when front suspension 300 is leaned to its maximum extent, either left or right. In one embodiment, mechanism arms 360 are machined from metal and stops 362 are molded from rubber, plastic, or another polymer material. Stops 362 are slid into mechanism arms 360. A detent can be used to keep stops 362 in place. In other embodiments, stops 362 are press fit into mechanism arm 360.

Suspension stops 362 can be made of compressible elastic material to allow the side on the inside of a turn to collapse beyond 45 degrees. A mechanical spring could also be used for suspension stops 362 instead of an elastic spring material. Both the elastic material and mechanical spring are tunable to impart various spring rates through mechanical adjustment or direct replacement of stops 362 within mechanism arms 360. Spring rate may vary depending on desired ride characteristics and the spring rate needed to return suspensions 300 and 700 to a non-inverted parallelogram state of operation or a below 45 degree lean angle.

Tie bars 370 are attached from the shaft of pulley 610 out to wheels 364. As a rider turns the handlebars, rotational energy is transferred through a cable to turn pulley 610. The turning of pulley 610 is translated to linear movement of tie bars 370 toward one wheel 364 or the other depending on the direction of turn. Tie bars 370 rotate wheels 364 relative to the rest of front suspension 300 to turn quad 100.

FIG. 3g illustrates a close-up view of the interface between pulley 610, Pitman arm 630, and tie bars 370. Tie bars 370 include a linear portion 370b extending outboard to CV joints 380 of wheels 364, and a dog-leg portion 370a inboard at Pitman arm 630. The dog-leg portion 370a can be manufactured separately or together with linear portion 370b. Dog-leg portions 370a are configured to align the inboard ends of linear portions 370b so that both linear portions are co-linear or at least symmetrical. Tie bars 370 with symmetrical linear portions 370b causes both wheels to turn the same amount even though the tie bars are attached at different radii of the Pitman arm 370 rotation.

Dog-leg portions 370a include a slotted opening 612 that Pitman arm 630 extends through. Slots 612 are only formed on one side of the opening in each tie bar 370 to allow a circular bearing to be inserted through the other side. Slots 612 limit the rotation of tie-bars 370 forward and backward. Rotation of dog-leg portions 370a would change the positioning of linear-portions 370b and potentially cause the steering response of the left and right wheels 364 to be different from each other.

Electric motors 378 include clevis joints in the middle of suspension 300 that are attached to block 310 by an axle extending through the clevis joints and into openings 344. Gear reductions 372 are mounted onto the outboard side of each motor 378. Axles 374 extend out from gear reductions 372 toward wheels 364. Electric motors 378 that power front wheels 364 are integral to the axle 374 of the wheels. Axles 374, which transfer power to roll wheels 364 forward and backward, extend out to the wheels between upper control arm 354 and lower control arm 356. In other embodiments, electric motors 378 are integrated into the hub of the wheels rather than at the inboard end of the axles. The hub based electric motors can turn wheels 364 by applying a counter-force to control arms 354 and 356 rather than having to have an axle 374 specifically for power delivery.

FIG. 3e is a perspective view of front suspension 300 from a slightly overhead angle. Additional details of the wheel 364 assembly are shown. Wheels 364 are mounted directly onto the external housing of a constant velocity (CV) joint 380 at the hub of each wheel. In some embodiments, CV joint 380 is integrated into a single pieced with the hub of wheel 364. CV joint 380 allows for a constant angular velocity of wheel 364 relative to axle 374 across the full range of quad 100 leaning and turning. The top of CV joint 380 is attached to upper control arm 354 by a hinge 382. The bottom of CV joint 380 is attached to lower control arm 356 by a hinge 384. CV joint 380 completes the parallelogram between upper control arm 354, lower control arm 356, and mechanism arm 360. As hydraulic actuator 350 pushes or pulls on mechanism arms 360, upper control arm 354 is moved left-right relative to lower control arm 356 to lean wheels 364. Hinges 382 and 384 allow the leaning to occur, while CV joint 380 allows power to be transferred smoothly from electrical motors 378 over a wide range of leaning angles.

The left and right lower control arms 356 are attached to each other by two pairs of offset clevis joints 390 at the center of suspension 300. A clevis joint is a hinge with two separate tines connected to an axle and a gap between the tines. The offset clevis joints 390 are formed with the two tines offset from center. Two clevis joints 390 are connected to each other with one of the tines of each clevis joint in the gap between the tines of the other clevis joint. The tines are offset with one lower control arm 356 having tines more toward the front of the vehicle and the other lower control arm having tines more toward the rear of the vehicle. Having the tines offset properly results in lateral tubes 392 of each lower control arm being directly across from each other and the same distance from the front of the vehicle.

FIG. 3f illustrates a perspective view from the front of suspension 300 and slightly below the suspension. Both pairs of offset clevis joints 390 are visible. The front clevis joints 390a are attached to an axle between front plate 316 and protrusion 324 of center block 310. The rear offset clevis joints 390b will be attached to an axle in mounting point 228 of front frame 220. The bottom of pulley 610 is visible, with a Pitman arm 630 extending forward that tie bars 370 are attached to. Tie bars 370 are attached forward from the vertical shaft of pulley 610 to convert the rotational motion of the pulley to lateral movement of the tie bars.

The outboard ends of tie bars 370 are attached to the CV joint 380 housing at ball joints 386, seen in FIG. 3e. Ball joints 386 allow tie bars 370 to push or pull on one side of CV joints 380 to rotate wheels 364 left-right and turn quad 100. Ball joints 386 also allow leaning of wheels 364 relative to center block 310 while still operating to turn wheels 364.

The perspective views of FIGS. 3e and 3f also illustrate longitudinal tubes 394 of upper control arms 354 and longitudinal tubes 396 of lower control arms 356. Longitudinal tubes 394 and 396 are the tubes that stop 362 of mechanism arms 360 press against at the end of the vehicle's leaning range. Stop 362 of a side presses against longitudinal bar 396 when quad 100 leans all the way toward the respective side of suspension 300, and presses against longitudinal bar 394 when the quad leans maximally away from the respective side.

FIG. 3h illustrates suspension 300 leaning toward the left side of quad 100, viewed from the front of the suspension. The right side hydraulic actuator 350 is expanded, while the left side hydraulic actuator 350 is compressed, to lean suspension 300. Lower control arms 356 keep the bottom of CV joint 380 at an approximately constant distance from the center of the vehicle, while the pushing and pulling of hydraulic actuators 350 moves the top of the CV joint left to lean wheels 364. Hinge 382, hinge 384, ball joint 386, and CV joint 380 allow wheels 364 to lean while still being turned by tie bars 370 and rotated by electric motors 378.

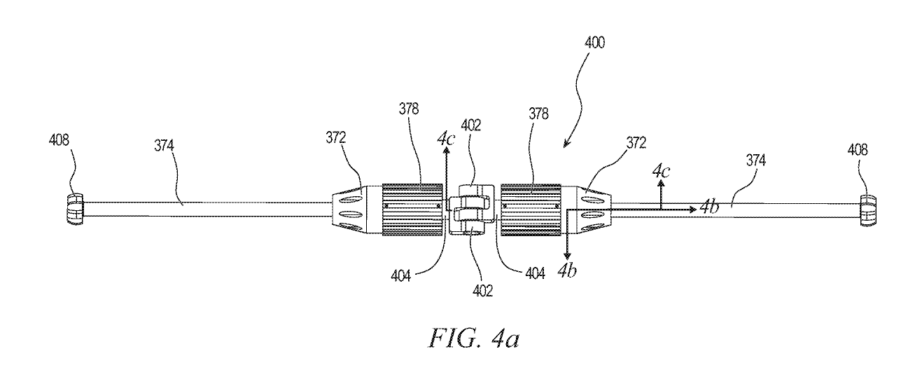

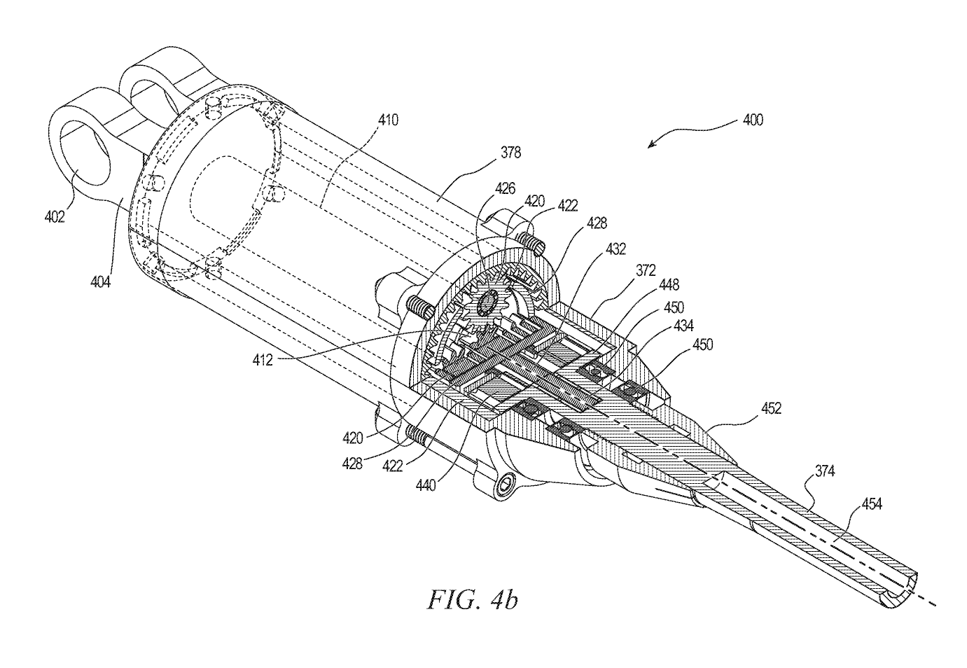

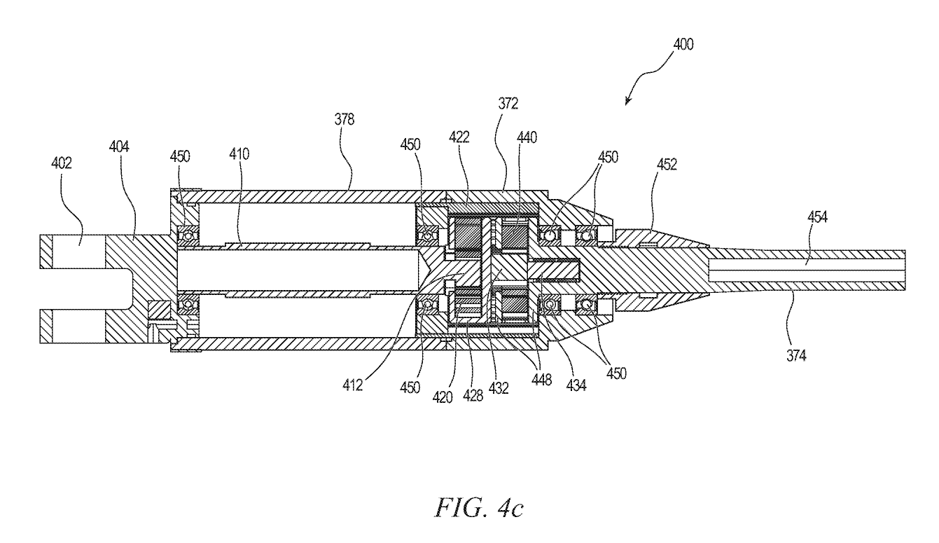

FIGS. 4a-4c show additional detail of the electrical drive train 400 of front suspension 300. FIG. 4a is a perpendicular view of drive train 400 showing offset clevis joints 402. Each clevis joint 402 includes one tang that is more centered, and one tang that is further from center. The two clevis joints are mirror images of each other so that they can be mounted on a common shaft or axle between openings 344 of center block 310 while maintaining symmetrical shafts 404 out to electrical motors 378.

Electrical motors 378 are attached to shafts 404 from clevis joints 402. Electrical motors 378 receive electrical power from a control system of quad 100 and turn a power take-off (PTO) shaft to gear reduction 372. The PTO of electrical motors 378 turns at a higher rate of speed than desired for the turning of wheels 364. Gear reduction 372 is used to reduce the rotational speed and increase torque from motor 378 to axle 374. The opposite end of axle 374 from motor 378 includes a ball 408 that is inserted into CV joint 380 to turn wheels 364.

FIGS. 4b and 4c illustrate sectioned views of gear reduction 372 to show operational details. PTO 410 is the shaft that is directly turned by electric motor 378. PTO 410 includes a pinion gear 412 on the end of the PTO. As pinion gear 412 is turned by electric motor 378, the teeth of the pinion gear interface with teeth of planetary gears 420. Planetary gears 420 are positioned between planetary ring gear 422 on the outside and pinion gear 412 on the inside. The complementary forces of pinion gear 412 rotating and planetary ring gear 422 being static results in planetary gears 420 travelling along the circumference of gear reduction 372 around pinion gear 412. Planetary gears 420 travel around pinion gear 412 at a slower rate than the pinion gear is spinning because of planetary ring gear 422 being held static.

Planetary gears 420 are each mounted on an axle 426, which is further attached to planetary cage 428. As planetary gears 420 rotate around pinion gear 412, planetary cage 428 is spun coaxially with pinion gear 412 by the planetary gears. Planetary cage 428 includes a secondary pinion gear 432 that spins in a similar manner to pinion gear 412 but at a slower rotational speed. Pinion gear 432 turns planetary gears 440 between the secondary pinion gear 432 and planetary ring gear 422. Planetary gears 440 move around pinion gear 432 in a similar manner to planetary gears 420 moving around pinion gear 412. Planetary gears 440 are mounted on axles in planetary cage 448, which is rotated by the planetary gears in a similar manner as planetary cage 428. Axle 374 out to wheel 364 is a part of planetary cage 448. Axle 374 rotates around the same axis as the initial PTO 410, but stepped down in rotational speed from PTO 410 to pinion gear 432, then again from pinion gear 432 to axle 374. Axle 374 is integrated into, i.e., formed as a single piece with, planetary cage 448. Planetary cage 448 and axle 374 can be formed as a single piece by additive or subtractive manufacturing methods, or by combining multiple pieces of separately machined material. While two reduction stages are illustrated, only a single stage, or any number of additional stages, could be used in other embodiments.

An extension 434 extending from pinion gear 432 into the end of axle 374 helps stabilize the relative rotation of planetary cages 428 and 448. Ball bearings 450 around axle 374 and PTO 410 reduce friction of the shafts rotating. A fastener nut 452 is screwed onto threading of axle 374 to hold bearings 450 in place and seal the gear reduction housing from external contaminates. A cavity 454 within axle 374 is provided for weight reduction and can be extended to the inboard end of the axle to provide additional room for storage of oil or lubricant for gear reduction 372.

In one embodiment, the starter of the quad's combustion engine is removed and replaced with a redesigned gear set. The replacement for the starter operates as an electrical generator that provides electrical power to the front drive motors. The electrical signal from the engine to the front electrical motors eases routing requirements relative to a mechanical drive system between the engine and front wheels. Only a limited number of electrical wires needs to be routed. The generator can be surrounded by a water jacket to water cool the generator using the same coolant already flowing through the engine. The generator is small but fast, operating at between 50,000 and 80,000 revolutions per minute (RPM) to output between 8-10 kilowatts of power in one embodiment. The generator can be phase adjusted to turn it back into a motor to start the engine or to free wheel at higher speeds.

In some embodiments, wheels 364 include unidirectional bearings coupling wheel 364 to axle 374. The unidirectional bearings allow wheels 374 to turn when quad 100 is coasting forward without axle 374 also turning. Allowing the gears of gear reduction 372 to rest when quad 100 is coasting reduces thermal load. Adding unidirectional bearings eliminates the ability to have electric motors 378 drive quad 100 in reverse. The combustion engine powering the rear wheels can be geared to drive quad 100 in reverse, or a smaller electric motor can be coupled to a third gear or sprocket on jackshaft 804 to drive the quad backward.

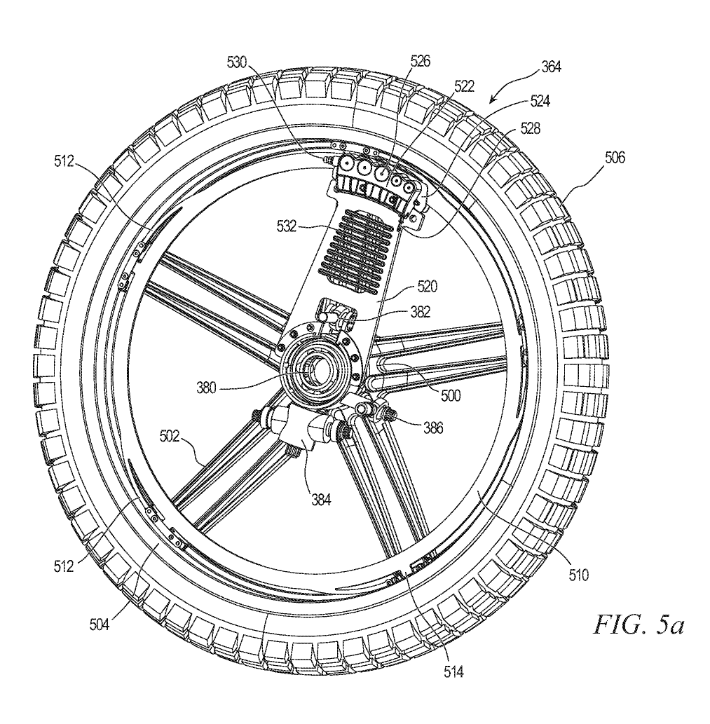

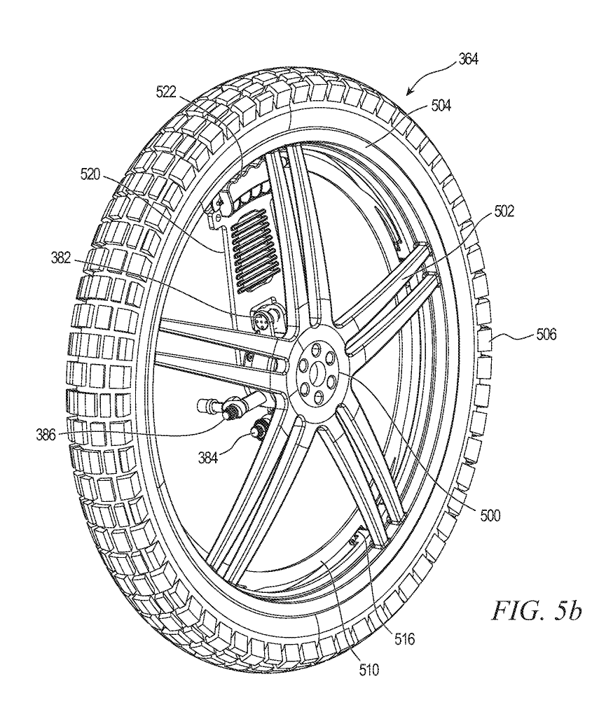

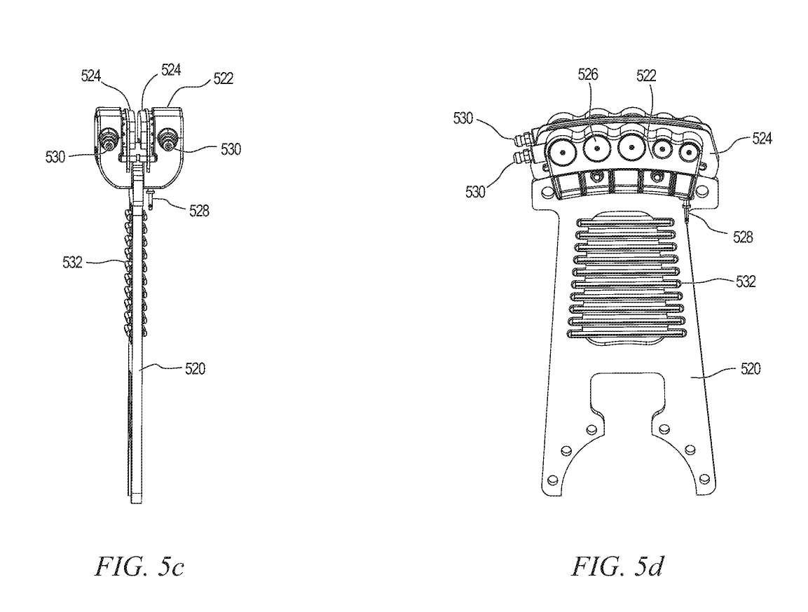

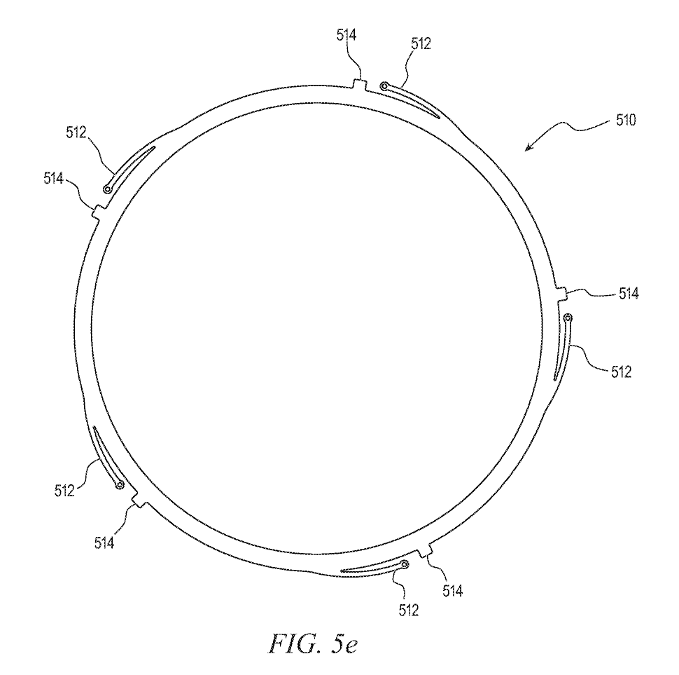

FIGS. 5a-5e illustrate the brakes of quad 100. Each of the four wheels 364 has a similar braking system as illustrated. However, the front and rear brakes may have differently sized brake pads or a different number of brake cylinders depending on the relative loads expected. FIG. 5a shows the wheel 364 assembly from the inboard side. Wheel 364 is mounted onto a housing of CV joint 380. Ball 408 of axle 374 is disposed in the visible opening in CV joint 380 during operation. Wheel 364 includes a hub 500 directly attached to or integrated with CV joint 380 opposite axle 374, which turns with the axle. Spokes 502 extend from hub 500 to a rim 504. Tire 506 sits on rim 504 to provide a cushioned ride and adequate traction.

The braking system includes brake rotor 510 attached on the inner circumference of rim 504. Rotor 510 is attached to rim 504 by springs 512. Springs 512 allow rotor 510 to remain in alignment relative to its designed mounting position while still allowing side movements as the rim flexes under extreme riding conditions. Springs 512 also impart a preload force to rotor 510 to mitigate rotor shock during braking loads. The amount of give of springs 512 is limited by load carrying tangs 514 extending from the outer edge of rotor 510. Tangs 514 are disposed between a protrusion 516 of rim 504 and a cover 518 screwed to the protrusion on the opposite side of the tang. Tangs 514 hit either protrusion 516 or cover 518 when rim 504 bends beyond a desired threshold. The force of protrusion 516 or cover 518 against tangs 514 causes the rotor to bend along with the rim beyond the threshold.

Protrusion 516 curves around the front and back of tangs 514 to provide screw holes to mount cover 518. The screws through covers 518 also holds onto the ends of springs 512. Cover 518 includes two arms that extend into protrusion 516 in front of and behind tangs 514. Tangs 514 hit the arms of covers 518 to keep brake rotor 510 from significantly rotating forward or backward within rim 504. Cover 518 is made of a hard material to protect the softer aluminum or carbon fiber of rims 504 from damage as tangs 514 receive load from applied braking forces. The arms of cover 518 also provides a lower friction surface for tangs 514 to rub against as rims 504 flex under load.

A stanchion 520 is attached to CV joint 380 and extends toward rim 504 to hold a brake caliper 522 around rotor 510. Caliper 522 is center-mounted at the top of stanchion 520 with two brake pads 524. The two brake pads 524 are mounted on opposite sides of rotor 510. A plurality of brake cylinders 526 in caliper 522 is hydraulically expanded to squeeze rotor 510 between the two brake pads 524, thus slowing down or stopping the motion of quad 100. A hydraulic brake line is attached to hydraulic port 528 to actuate brake cylinders 526. Each side of caliper 522 includes a bleeder valve 530 to remove air from the hydraulic brake system.

Stanchion 520 includes a plurality of fins 532 to aid in air-cooling the brakes and increase structural integrity. Friction between brake pads 524 and brake rotor 510 generates significant thermal energy to slow down or stop quad 100. Caliper 522 is designed around a centered fulcrum connecting the two banks of brake cylinders at the stanchion mounting. Selective laser sintering (SLS) or another additive or 3D printing manufacturing process can be used in manufacturing caliper 522 to reduce the overall weight and part count of the brake system. Additive manufacturing also facilitates proper positioning of internal brake fluid passages.

The braking pressure of brake pads 524 against rotor 510 increases the pressure of caliper 522 on stanchion 520, which facilitates greater thermal transfer from the caliper to the stanchion. Fins 532 and the openings between the fins increase the surface area of stanchion 520 that air flows against to help transfer the thermal energy to ambient air. In addition, the clamping pressure of caliper 522 against stanchion 520 when braking reduces torsional flex of the stanchion from braking forces. The centered fulcrum design reduces torsional deflection moments in stanchion 520 as braking force is applied, allowing the stanchion to be designed to flex with rim 504 because the stanchion does not need to handle torsional loads. Rotor 510 can be made smaller because the rotor does not have to resist lateral loads from caliper 522.

FIG. 5b shows wheel 364 from the outboard side. The opposite side of caliper 522 is seen on the outboard side of rotor 510. FIG. 5c illustrates stanchion 520 from a head-on view to show the gap between brake pads 524 where rotor 510 is disposed. Hydraulic pressure at port 528 is transferred to one or more cylinders 526 on each side of caliper 522. Cylinders 526 convert the hydraulic pressure to physical movement of brake pads 524 inward to contact rotor 510, and then apply increased pressure to slow or stop quad 100. The hydraulic pathway from port 528 is split to the two sides of caliper 522. A bleeder valve 530 is provided on each side of caliper 522 so that air can be bled from both hydraulic paths separately. FIG. 5d illustrates stanchion 520 and caliper 522 in isolation from the rest of wheel 364, and FIG. 5e illustrates rotor 510 in isolation.

FIGS. 6a and 6b illustrate the cable steering system of quad 100. Two cables 620 run in parallel from pulley 600, where handlebars are attached through steering tube 204, across pulleys 602, 604, and 606 to pulley 610. Cables 620 each include ferrules or another mechanism to hold the ends of the cables in pulleys 600 and 610. Cables 620 are aircraft cable with a 2,000 pound capacity in one embodiment. In other embodiments, any suitable cable is used. Cables 620 are pre-loaded with 300 pounds of tension in one embodiment. The pre-load reduces the amount of stretch or give in the steering so that movement in the handlebars correlates better with movement in wheels 364, rather than having some of the handlebar movement absorbed in stretching of cables 620.

When handlebars are rotated to turn left, the leftward cable 620 is given some slack by pulley 600 while the rightward cable 620 is pulled by pulley 600. The rightward cable pulls pulley 610, which rotates approximately the same as pulley 600. Pulley 610 picks up the slack of the leftward cable 620. Similarly, when turning right the leftward cable 620 pulls from pulley 600 to pulley 610. Pitman arm 630 is shown in FIG. 6b. Pitman arm 630 converts the rotational motion of pulley 610 into linear movement of tie bars 370. The inboard ends of tie bars 370 are offset so that the motion at the outboard ends of both tie bars is approximately equal even though the tie bars are connected to Pitman arm 630 at different distances from pulley 610.

FIGS. 7a-7g illustrate rear suspension 700. FIGS. 7a and 7b show center block 710, which is similar to center block 310 of front suspension 300. Features that retain the same reference number from center block 310 operate similarly or serve a similar purpose. Middle portion 712 is extruded to any suitable length, and then front plate 716 and back plate 714 are welded on at openings 320. As with block 310, middle portion 712 can be machined or cast, or the entire block 710 can be machined or cast as a single piece. Openings 330 are used to bolt suspension 700 onto rear frame 240. Openings 331 accept protrusions from flanged ends 247 that helps align frame 200 to suspension 700. Hitch receiver openings 338 are used to add functional or decorative components onto the back of quad 100. Control links 352 are coupled to openings 340 by an axle. The back ends of the lower control arms are coupled together at an offset clevis joint between back plate 714 and protrusion 324.

Shock actuators are disposed in cavities 336 and connected by an axle through openings 334. In one embodiment, cavities 336 are the same size in center blocks 310 and 710, while center block 710 of rear suspension 700 has an overall longer extruded middle portion 712 in order to provide sufficient thickness to hold a differential at the bottom of the center block. Middle portion 712 includes circular recesses 720 for holding the differential. Front plate 716 includes a cutout 722 to allow a belt to be routed around the differential. Mounting brackets 726 are installed over the differential and bolted onto middle portion 712 to hold the differential onto center block 710.

FIG. 7c shows a head-on view of rear suspension 700 from the front, i.e., the side that attaches to frame 200. Differential 724 is seen in the bottom of center block 710. Differential 724 optionally includes ribs formed around its outer circumference for use with a toothed belt. In other embodiments, a flat belt, a V-shaped belt, a chain, or another suitable mechanism is used. The belt is turned by a combustion engine of quad 100 as shown in FIGS. 8a and 8b. Differential 724 transfers the rotational energy out to wheels 364 via axles 730. Differential 724 is geared to allow the left-rear wheel 364 to rotate at different rate from the right-rear wheel. FIGS. 8c-8e illustrate further detail of differential 724.

FIG. 7d illustrates suspension 700 leaning to the left side of quad 100. Leaning of rear suspension 700 operates similarly to front suspension 300. Hydraulic actuators push and pull on mechanism arms 360 to move upper control arms 354 relative to lower control arms 356. The primary differences between front suspension 300 and rear suspension 700 are, first, that the rear suspension is powered by a combustion engine while the front suspension is powered by electrical motors and, second, that the rear suspension does not have a steering mechanism. However, in other embodiments, rear suspension 700 could include electrical motors 378 as with front suspension 300 rather than a belt driven differential. Moreover, quad 100 could use four wheel steering with steering cables routed to rear suspension 700 in addition to front suspension 300. In some embodiments, the sizes of the tires or rims of the front and back tires are different, depending on the requirements of the specific vehicle.

FIG. 7e illustrates suspension 700 from a slightly overhead perspective. Axles 730 extend from CV joints 380 of wheels 364 to CV joints 732 on either side of differential 724. CV joints 380 and 732 allow differential 724 to turn wheels 364 via axles 730 at any leaning angle that quad 100 is capable of. FIG. 7f shows detail of the suspension leaning with axle 730 at a significant angle relative to CV joints 380 and 732. As discussed above, there was an issue with the figures that caused CV joints 732 and 380 to not have their shafts rotated properly. One having ordinary skill in the art would understand that the shafts in CV joints 380 and 732 would remain continuous with axle 730. FIG. 7g illustrates the back end of rear suspension 700 from a perspective below the suspension.

The braking of rear suspension 700 works substantially the same as with front suspension 300. Calipers 522 are on stanchions 520 extending from CV joints 380. Calipers 522 are center-mounted on stanchions 520, and each holds a pair of brake pads 524 flanking a circular rotor 510. The rotor 510 is held onto rim 504 by springs 512 to allow the rims to flex without bending the rotors.

FIGS. 8a and 8b illustrate the linkage between a combustion engine mounted on platform 210 and differential 724 from two different views. Chain 800 is looped around a gear turned by the combustion engine. The combustion engine and the gear turned by the engine's PTO are not illustrated, but the gear would be located within the loop of chain 800 indicated by the reference number 801. The exact location could be different in other embodiments, and chain 800 could be routed differently to accommodate.

Chain 800 transfers power from the engine to a gear 802 on jackshaft 804. Gear 802 is turned by chain 800, which turns jackshaft 804. Jackshaft 804 has eccentric caps 806 on the two ends of the jackshaft. Eccentric caps 806 are used to hold jackshaft 804 onto frame 200 in mounting brackets 808. Eccentric caps 806 are not allowed to rotate within brackets 808 during normal operation of quad 100, but the bracket can be loosened to adjust the tension of chain 800. When brackets 808 are loosened, eccentric caps 806 rotate within brackets 808 off-center from the rotation of jackshaft 804 within the caps. Turning eccentric caps 806 within brackets 808 moves jackshaft 804 closer or further from the combustion engine, which changes the distance between gear 802 and the non-illustrated gear at 801 and thereby controls tension of chain 800.

Jackshaft 804 has a second gear or sprocket 810 with teeth that matches the teeth around differential 724. Belt 820 is routed around gear 810 and differential 724 to transfer power from jackshaft 804 to the differential. Tension of belt 820 is adjusted using tension pulley 822, which is mounted to center block 710 by a bracket 824.

FIG. 8c shows differential 724 separate from center block 710. Belt 820 extends around the circumference of differential 724, with the belt's teeth interleaved with teeth of the differential's sprocket 832. Shell 840 is turned along with sprocket 832. Differential 724 is held between center block 710 and bracket 726 by a ball bearing around ridge 834. Sprocket 832 turns CV joints 732 on both sides of differential 724 through a system of internal gears.

FIG. 8d illustrates differential 724 with CV joint 732 and shell 840 removed from one side. Composite bearings between shell 840, CV joint 732, and spindle 846 are also removed. Differential 724 works similarly to the differential gear box in U.S. Pat. No. 8,387,740 (the '740 patent), which is incorporated herein by reference. In some embodiments, one of the halves of shell 840 includes a groove formed completely around differential 724 on surface 841. When the two halves of shell 840 are bolted together through openings 842, an O-ring is disposed in the groove to fully seal the differential. Grooves can be formed around the axles of spindle 846 to complete the groove all the way around differential 724. The sides of the differential will be sealed by CV boots disposed over CV joints 732.

Spindle 846 and spider gears 844 revolve around differential 724 at the same speed as belt 820 turns sprocket 832. Spider gears 844 turn around axles extending from spindle 846 to sprocket 832 when the left and right wheels turn at different speeds. Spider gears 844 are referred to as bevel gears in the '740 patent and include gear teeth that are not illustrated. The teeth of spider gears 844 turn CV joints 732 as sprocket 832 turns. Polymer or composite bearings 850 sit between the axles of spindle 846 and spider gears 844 to reduce friction.

FIG. 8e shows an exploded view of differential 724. Composite bearings 852 are disposed between CV joints 732 and spindle 846 to reduce friction. Composite bearings 854 are disposed between CV joint 732 and shell 840 to reduce friction. Composite bearings 850, 852, and 854 are formed from any suitable composite or polymer material. In other embodiments, the bearings are formed from brass, copper, other metals, or other metal alloys. Retaining rings 860 sit in grooves 862 of housings 840. Retaining rings 860 help hold all the parts of the differential together and keep belt 820 aligned with sprocket 832.

The primary difference between the differential of the '740 patent and differential 724 is that the '740 patent's roller bearings are replaced with composite bearings or bushings. Composite bearings work well in differential 724 because the parts on either side of each composite bearing 850, 852, or 854 move at similar speeds to each other. When quad 100 is travelling in a straight line, CV joints 732 rotate at approximately the same speed as sprocket 832. Moreover, spider gears 844 stay approximately static on spindle 846. There is no significant friction on the composite bearings from parts spinning relative to each other. The parts where composite bearings are used only spin relative to each other to the extent that the left and right wheels 364 are turning at different speeds. Composite bearings can have self-lubricating properties that are more than sufficient for differential use. Lubricants can be added to further reduce friction.

CV joints 732 are functionally similar to CV joint housings 90 in the '740 patent, and include teeth on their inner surfaces, similar to differential side gears 102 in the '740 patent, that are not illustrated. The teeth of CV joints 732 interface with the teeth of spider gears 844 so that the spider gears turn CV joints 732 as they revolve around differential 724. Spider gears 844 allow the two CV joints 732 to rotate at different speeds by rotating around the axles of spindle 846.

While one or more embodiments of the present invention have been illustrated in detail, the skilled artisan will appreciate that modifications and adaptations to those embodiments may be made without departing from the scope of the present invention as set forth in the following claims. While the invention is disclosed in terms of an all-terrain vehicle, the vehicle could be used as a street vehicle for commuting or any other purpose.

I claim:

1. A vehicle suspension, comprising:
a center block;
a suspension arm pivotally coupled to the center block;
a hydraulic actuator coupled between the center block and suspension arm; and
a wheel mounted to the suspension arm opposite the center block, wherein the hydraulic actuator is configured to lean the wheel.

2. The vehicle suspension of claim 1, further including a brake rotor mounted to a rim of the wheel.

3. The vehicle suspension of claim 2, wherein the brake rotor is mounted to the rim through springs.

4. The vehicle suspension of claim 2, further including a brake stanchion extending from a center of the wheel, wherein the brake stanchion includes a center-mounted brake caliper.

5. The vehicle suspension of claim 1, further including:
an axle pivotally coupled to the center block; and
a constant velocity (CV) joint mounted to a hub of the wheel with the axle extending into the CV joint.

6. The vehicle suspension of claim 5, further including a steering tie rod attached to a housing of the CV joint.

7. A vehicle suspension, comprising:
a center block;
a suspension arm pivotally connected to the center block; and
a hydraulic actuator coupled between the center block and suspension arm.

8. The vehicle suspension of claim 7, wherein the center block includes a hitch receiver opening.

9. The vehicle suspension of claim 7, further including:
a first electric motor pivotally connected to the center block;
a gear reduction coupled to a shaft of the first electric motor; and
an axle extending from the gear reduction.

10. The vehicle suspension of claim 9, wherein the axle includes a planetary gear cage within the gear reduction.

11. The vehicle suspension of claim 9, further including a second electric motor pivotally connected to the center block, wherein the first electric motor and second electric motor are mounted onto a common axle with offset clevis joints.

12. The vehicle suspension of claim 7, further including a differential attached to the center block, wherein the differential includes a composite bearing.

13. The vehicle suspension of claim 12, further including a jackshaft mounted eccentrically and mechanically coupled to the differential.

14. The vehicle suspension of claim 7, further including a steering cable attached to the suspension.

15. A method of making a vehicle, comprising:
providing a center block;
attaching a suspension arm to the center block; and
coupling an actuator between the center block and suspension arm.

16. The method of claim 15, further including:
providing a vehicle frame; and
attaching the center block to the vehicle frame.

17. The method of claim 16, wherein the vehicle frame includes a torsional box.

18. The method of claim 15, further including coupling the actuator to a mechanism arm of the suspension arm.

19. The method of claim 18, further including providing an interchangeable suspension stop in the mechanism arm.

20. The method of claim 15, further including forming the center block by extruding a middle portion of the center block.
